(19) United States
(12) Patent Application Publication
(10) Pub. No.: US 2002/0020604 A1
(43) Pub. Date: Feb. 21, 2002

(54) Component reject conveyor device

(76) Inventor: Jefferson J. Gaines, Tucson, AZ (US)

Correspondence Address: Richard R. Mybeck, Post Office Box 5540, Scottsdale, AZ, 85261-5540, US

(21) Appl. No.: 09/837,808

(22) Filed: Apr. 17, 2001

Related U.S. Application Data
(60) Provisional application No. 60/199,085, filed on Apr. 22, 2000.

(51) Int. Cl. B65G 37/00

(52) U.S. Cl. 198/348

(57) ABSTRACT

The present invention relates generally to an improved system for accepting, receiving and collecting rejected surface mount electronic components and more particularly to a system whereby a controllably intermittently operable conveyor belt accepts rejected components, maintains their separate identity, prevents further damage to the rejected component and allows the operator to inspect the rejected components without material interference with the production cycle. In an additional embodiment of the present invention, the system is also capable of limited supply functions as well, most likely in a counterflow direction.

This application claims the benefit of U.S. Provisional Application No. 60/199,085 filed Apr. 22, 2000.

### INTRODUCTION

The present invention relates generally to electronic component transportation systems. More particularly, the present invention pertains to anti-static conveyor systems for transporting surface-mount or like electronic components deposited thereupon. The system may be either unidirectional or bi-directional.

### BACKGROUND OF THE INVENTION

A great deal of attention had earlier been paid to the increased efficiency which can be gained by automation. In the electronics industry, for example, electronic surface mount components can now be automatically supplied via conveyor to host pick and place machines, or to robotic work cells (see e.g., U.S. Pat. No. 5,967,293). However, possibly surprisingly, relatively little attention has been directed to the care and handling of rejected components.

Prior inventions have created improved component feed conveyors where slots are used to feed components into respective nests. However, the use of conveyors for accepting, receiving, transporting or otherwise handling rejected surface mount electronic components has not previously been attempted, at least not so far as is known to applicant.

Total Quality Management, TQM, based upon the studies of W. Edwards Denning, Ph.D., Stern School of Business, New York University, has traveled full circle and returned from whence it was originated, the United States of America. This has many implications, some of which perhaps being germane to the present invention.

Several practices or principles of TQM, such as operator inspections, quality assurance, and the early determination of both special and systemic cases of defects, directly impact the inspiration for, and benefits of, the present invention. In times gone by, defective or rejected material, was consigned to the scrap heap, or the rework bin, without a thought or care. Thankfully, industry is now more efficient. The cause of defects and the early determination of the proper corrective action, are increasingly being seen as essential or at least highly desirable for a commercially viable production line.

Manual assembly and inspection has in many places been supplemented or even supplanted by automatic or even robotic assembly and inspection processes. However, these advances have created problems not previously known. The possibility of erroneous rejections has likely been increased. A sensor or programming error could easily result in the erroneous rejection of valuable, good, components. Similarly, with automated or robotic inspection, components could be rejected due to a minor, easily correctable defect. Further, during the setup process, automated erroneous rejections by automated systems are often unavoidable.

In the prior art, rejected components were considered to have no value beyond that of scrap. Rarely was information gathered from the scrap box. Scrap was scrap. No perceived benefit was to be gained by careful scrap handling; there was no reason to treat rejected material with particular care.

This outdated attitude has in large, been discarded with the advent of expensive subassemblies, and TQM. TQM has many facets and precepts. Of particular relevance here is the concept of quality assurance and the proposition that operators are in the best position to assure quality, conduct inspections, and detect errors. To allow an operator to identify errors or the basis of an automated part rejection, several conditions would seem to be necessary, if not always sufficient.

First, the rejected component must be kept in the same condition as which it was rejected. Second, the component must be accessible for operator inspection, sort or repair. Third, the operator must be alerted to the rejection.

Several additional conditions would also appear to be desirable. For example, the rejected components should not be subjected to further damage; the components should be kept as separated as possible; salvageable and non-salvageable material should not be combined; the production cycle should not be delayed or interfered with any more than is absolutely necessary; and lastly, for obvious reasons, the parts receptacle needs to be as compact as practical, suggesting the desirability of an intermittently operable, multiple-mode, capable rejected component conveyor belt.

Also, if rejected parts are handled with care, the same transport system may also be capable of handling good parts as well. In addition, some applications would greatly benefit from a conveyor which was reversible and could also serve as a feed conveyor.

So far as applicant is aware, to date, this need, at least in the area of surface-mount electronic components rejected by automated or robotic pick and place machines, has not been recognized, let alone addressed. It is toward the filling of this void that the present invention is directed.

### BRIEF SUMMARY OF THE INVENTION

The present invention relates generally to an improved system for accepting, receiving and collecting rejected surface mount electronic components and more particularly to a system whereby a controllably intermittently operable conveyor belt accepts rejected components, maintains their separate identity, prevents further damage to the rejected component and allows the operator to inspect the rejected components without material interference with the production cycle. In an additional embodiment of the present invention, the system is also capable of limited supply functions as well, most likely in a counterflow direction.

The component reject conveyor of the present invention is preferably both intermittently operable and programmable. This conveyor device preferably mounts directly on a host pick and place machine. A rejected component is picked up by the head of the host machine and placed on a selected, pre-programmed location on the rejected component conveyor belt.

Each pick-up and place cycle of a rejected component by the host machine, causes the conveyor belt to move by a selectable, variable, pre-determined amount. This increment may be determined by the parameters of the component in question and the controllable mode options of the present invention. This incremental movement can be actuated by the host, by a suitable sensor operatively connected to the conveyor belt as well as by the operator if desired. Such a suitable sensor could comprise for example, an electric eye of conventional nature.

In the preferred embodiment(s), control means will be operatively connected to the conveyor belt. The control means allows both the input of parametric or control data limits and/or for direct operator control input. An example of operator input would be for the operator to be able to cause the conveyor belt to advance a preset, though variable, distance. Control limits could be set, for example, to alert the operator after a preset number of iterations of the rejected component acceptance cycle, or, if the amount of non-utilized conveyor belt was below a preset quantity.

Ideally, the conveyor belt would be anti-static, protective, and durable. This is of particular importance when dealing with surface mount components which are expensive, fragile and sensitive to static electricity, for several reasons.

First, if an erroneously rejected component is to be inspected and placed back into service, its condition must be protected. Secondly, during the machine set-up process, erroneous component rejections are anticipated. However, when using the present invention, no particular care must be taken to prevent damage to rejected components, due to set-up errors, because all such components are protected. Third, preserving the condition of a rejected component is highly desirable so that the operator may be able to discover the source of quality errors and institute corrective or preventative action, when possible.

Accordingly, a primary object of the present invention is to provide a means whereby potentially defective surface mount electronic component parts can, after rejection, be maintained without further harm, pending subsequent operator inspection.

Another object of the present invention is to provide a method of receiving and/or accepting host rejected surface mount electronic parts for later inspection comprising attaching a controllable, programmable, intermittently operative conveyor to a host machine, wherein the host machine compares component parts to a predetermined standard and parts failing to meet such standards are deposited upon and received by the conveyor device.

A further object of the present invention is to provide a means of safely storing, for subsequent inspection, rejected parts, wherein the means have both automatic and manual control.

Yet another object of the present invention is to provide a reversible reject conveyor which can, when reversed, function as a supply conveyor.

These and still further objects as shall hereinafter appear are readily fulfilled by the present invention in a remarkably unexpected manner as will be readily discerned from the following detailed description of an exemplary embodiment thereof especially when read in conjunction with the accompanying drawing in which like parts bear like numerals throughout the several views.

### BRIEF DESCRIPTION OF THE DRAWINGS

In the drawings:

FIG. 1 is an isometric view of a component reject conveyor device according to the present invention;

FIG. 2 is an isometric, fragmentary view of an alternative embodiment of the component reject conveyor device of FIG. 1;

FIG. 3 is an enlarged, fragmented elevational view, partially broken-away, of a portion of the conveyor of FIG. 1;

FIG. 4 is a generalized circuit diagram showing the main electrical circuitry of a preferred embodiment of the present invention; and

FIG. 5 is another, more-detailed circuit diagram of the main electrical circuitry of a preferred embodiment of the present invention.

### DESCRIPTION OF THE PREFERRED EMBODIMENT

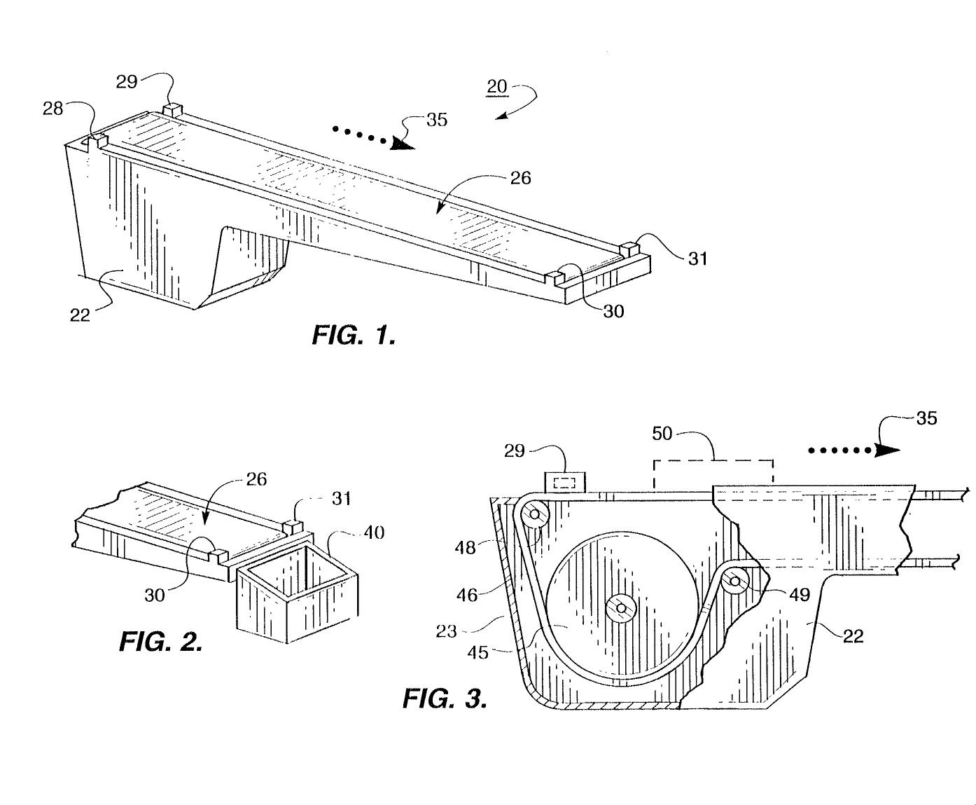

A component reject conveyor device according to the present invention is shown in the accompanying drawings and is identified generally by the reference numeral 20 therein. As shown most basically in FIG. 1, component reject conveyor 20 generally includes a housing 22 and a conveyor means comprising a component conveyance portion 26.

Housing 22 is adapted to be securely mounted in an electronic assembly system as is generally known in the art. As shown in FIG. 1, also disposed on the housing 22 are two sets of sensors 28, 29 and 30, 31. Sensors 28, 29 are disposed in what appears from FIG. 1 to be the rear of the device to sense when a rejected component is placed upon the component reject conveyor device 20. Device 20 will then be activated to move the conveyance means in the forward direction indicated by the arrow labeled 35 in FIG. 1. Sensors 30, 31 are located at the relative front end (as appears from the drawing) of the conveyance portion 26. Sensors 30, 31 would then sense the arrival of a rejected component to that location.

FIG. 2 shows an alternative embodiment in which a receiving means or container 40 is disposed at the end of the conveyance portion 26 to, in this alternative embodiment, receive rejected components. This and other alternative embodiments will be described in more detail below.

FIG. 3 shows more detail of a conveyor means according to the present invention. In particular, the conveyor means 26 is shown including a primary roller drum 45 inside housing 22, drum 45 being disposed to move a conveyor belt 46 through and/or over the device 20. Two guide rollers 48, 49 are also shown as they would, in a preferred embodiment, assist in positioning the belt within the device 20. A rejected component 50 is shown in dashed lines as it would rest on the conveyor belt 46 during a journey in the direction of the arrow labeled 35 (as in FIG. 1).

As shown best in FIG. 3, the conveyor means generally and preferably includes a continuous conveyor belt loop 46. The conveyor means preferably intermittently moves each component, in a stop and go fashion, from the receiving area between sensors 28, 29 where each component comes to rest at a disposition point where it was deposited by the automated/robotic pick-and-place machinery, towards the scrap receptacle 40 in the FIG. 2 embodiment, or simply to the location where the sensors 30, 31 would sense the arrival of a component and signal for or otherwise trigger the removal thereof by other means (human, or automated or robotic or pick and place machinery).

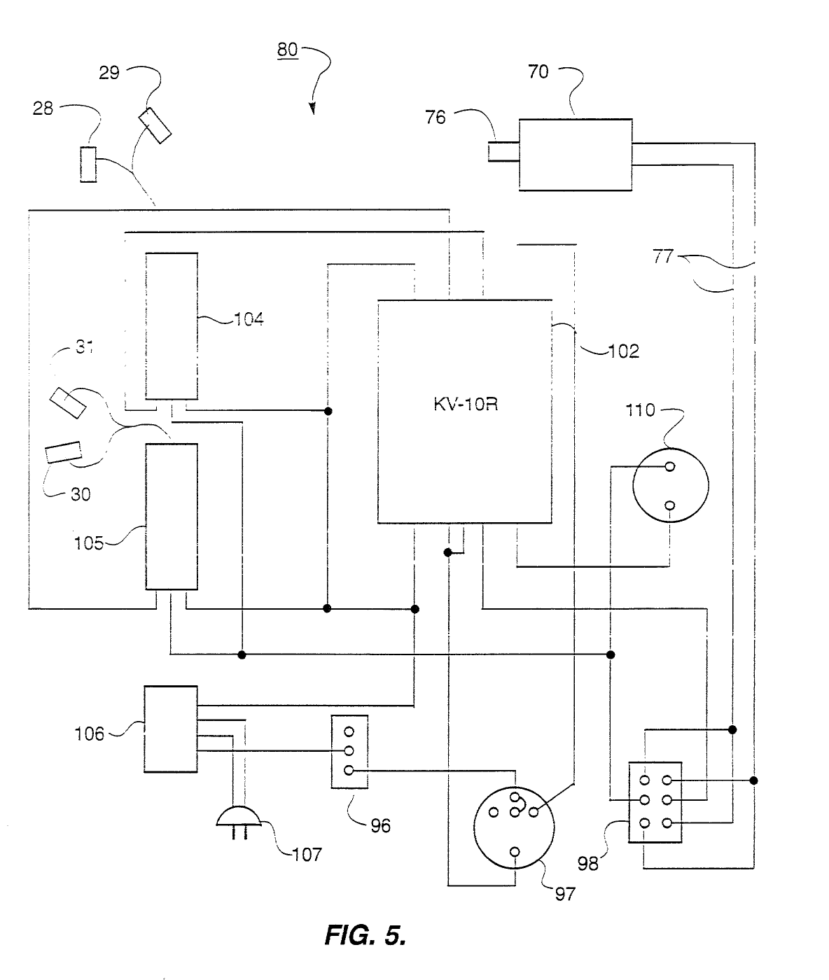

The internal, motion-generating sub-structures are not described here in detail; rather details of a substantially preferable form are included in the specification of application Ser. No. 08/697,909; now U.S. Pat. No. 5,967,293 which description is incorporated herein by this reference thereto. Such sub-structures would include, generally, a preferably electrically-powered conveyor belt motor assembly which would drive the roller drum 45 which would then, in turn, drive the conveyor belt 46. The major parts of preferable such motion-generating sub-structures are shown and described with respect to FIGS. 5 and 6, inter alia, in the above referenced patent document, U.S. Pat. No. 5,967,293.

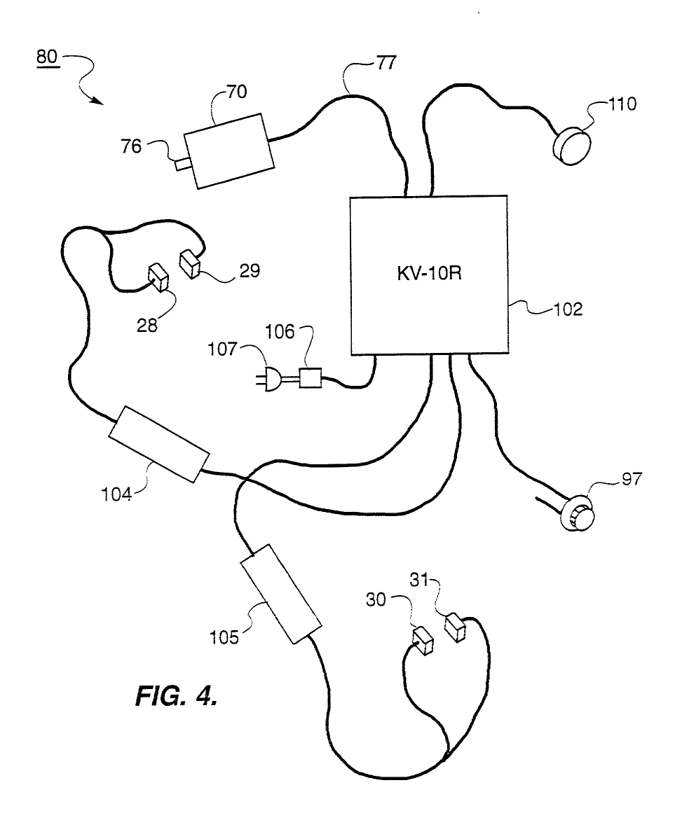

In any event, when activated, a motor 70 (see FIGS. 4 and 5 as described below) turns a shaft 76 which ultimately drives belt drum 45 to move belt 46 in the desired direction to move the corresponding component(s) disposed thereon. A power connection 77 (shown generally in FIGS. 4 and 5) connects motor 70 to the control circuitry 80, which will be described in greater detail below. In general, control circuitry 80 governs when gear motor 70 is turned either on, to move the conveyor belt 46, or off, to stop the conveyor belt 46.

The control means used to trigger these motion-generating sub-assemblies can be any device or combination of devices which triggers motor 70 “on” and thus the movement of conveyor belt 46 for a given interval (time, distance or otherwise triggered “off”). Preferably, such a trigger “on” is based on an action of the separate pickup machinery, which as herein described, is the physical disposition of the pickup machinery head and/or the component in the reject placement position on the conveyor belt 46. One or more optical sensors 28, 29 (see FIGS. 1, 3, 4 and 5) are preferred for sensing this disposition and then sending a signal to the other parts of the control means which will then perform the appropriate actions. Electrical circuitry 80 is a primary part of this control system which receives appropriate signals from sensors 28, 29 which then causes the appropriate mechanical responses as described below.

However, before elaborating on the details of a preferred electrical circuitry system (as shown for example in FIGS. 4 and 5), a more general description of the preferred approach will be set forth. Component reject conveyor device 20 is designed to automate the reception of electronic components from robotics, pick and place, or other automated assembly systems. As a subsystem that can be integrated into any automated or robotic system, component reject conveyor 20 must be flexible in its characteristics such as in sequencing, component movement rate, dwell time, and braking.

Conveyor device 20 is preferably turned on by engaging a power switch 96 (see FIG. 5). At this point, conveyor device 20 is powered up but is in an idle mode waiting for an event to happen. An event has occurred when the robotic or automated pick and place system places a rejected component 50 (not shown in FIGS. 4 and 5) on the conveyor belt 46 between the sensors 28, 29. As the component pick head disposes the rejected component on the conveyor means or belt 46, this breaks the electric eye light beam passing between sensors 28, 29 and sends a signal back to the light sensor amplifier 104 (see FIGS. 4 and 5). Amplifier 104 is sensitive to or programmable to be sufficiently sensitive to the duration (or other indication) of the break in the light beam. If the duration of the break in the light beam qualifies as an acceptable component part placement, then amplifier 104 will provide a contact closure that can initiate the belt movement procedure. The belt movement procedure starts with the activation of the main circuit chip 102 (see FIGS. 4 and 5; also labeled KV-10R in accord with a preferred and known chip type in the electronics industry).

Then, after a period of movement (time, distance or otherwise; see below), the motor 70 will be stopped, which stoppage may be triggered by one or more distinctive means. In the preferred embodiment, the two further sensors 30, 31 as introduced above may be used for this purpose (see below); however, other means may also be used including as an example, a timing means similar to that described in the above-described patent document, U.S. Pat. No. 5,967,293, in which the primary circuit chip 102 (KV-10R or another model, not shown) may have time delay characteristics, potentially controllable by a dwell potentiometer (not shown here, see also U.S. Pat. No. 5,967,293). Thus, motor 70 may be activated to run conveyor belt 46 either for a particular distance (adjustable), or until the component part reaches the second set of sensors 30, 31, or for the period of time set by manipulation of a dwell potentiometer (as in U.S. Pat. No. 5,967,293). Then, motor 70 is caused to stop, which stops conveyor belt 46. The primary function of the electrical control means is properly controlling and/or sequencing these operations.

Then, another component may be placed on the conveyor belt 46 between the sensors 28, 29, and the cycle of moving the conveyor belt as described above may be started again. Preferably, when the sensor initiated signal is sent from amplifier 104 to main circuit chip 102, then the main circuit chip 102 provides for the application of power through a switch 98 that allows also for operator control of the actual power supply to start motor 70 to turn belt 46. Once more, after the conclusion of the period of belt movement whether by distance, sensor activation (30, 31) or dwell time cycle (the length of the time cycle (if used) that belt 46 is moved), conveyor device 20 returns to the idle state to await either another event or a jog command input (see below).

A component “jog” button 97 (see FIG. 5; push-button preferred) may be included to allow an operator to incrementally activate/move the conveyor belt 46 forward. In the configuration shown in FIG. 5, depression of the push-button switch 97 will provide belt activation/movement for so long as the push-button 97 remains depressed.

A double-pole, double-throw (DPDT) switch 98 may also, as is here preferable, be included to regulate the power activation of motor 70. In an embodiment such as that shown in FIG. 5, switch 98 may be used to control the direction of motor/shaft 70/76 rotation and then also the direction of movement of belt 46. For example, if the switch is moved to activate top-most poles a and b of switch 98, then the motor 70 may be activated to move in a first direction, say for example, forward. However, if the switch is then moved to the bottom-most poles e and f, then the motor may be activated to move in the other direction, say in reverse. This allows for removing rejected components in a forward direction toward the forward sensors 30, 31 and/or the waiting receptacle 40; or in reverse allowing for feeding components toward the placement point for retrieval by the robotic/automated pick and place machinery, if desired. The middle poles c and d may be used for inactivating motion of the motor and belt.

A control panel (not shown, but preferably disposed on housing 22, e.g., on a back wall 23; see FIG. 3, but controls are not shown) may contain the operator variable and actuation controls to operate conveyor device 20. These controls are shown in a generally schematic fashion in FIG. 5. The main power line(s) 107 also is/are shown in FIGS. 4 and 5. Component reject conveyor 20 may preferably be powered by any of several alternative sources, either 120VAC, 24VAC or 24VDC. This combination of power alternatives provides flexibility for installation in existing robotic or other pick and place assembly systems.

A belt speed controller (also not explicitly shown) may additionally/alternatively be used (such as the potentiometer labeled 98 in the above-referenced U.S. Pat. No. 5,967,293) to limit power to motor 70 thus adjusting the speed of rotation of shaft 76 and thus also the speed of the conveyor belt 46. Motor 70 may be set to receive its power through main circuit chip 102 which could also then flow through a potentiometer (such as that shown and described in U.S. Pat. No. 5,967,293) thereby providing for limiting the power proportionate to the resistance presented by such a potentiometer which may be manually controlled by the user.

As introduced above, a dwell potentiometer (not shown here, see e.g. potentiometer 99 in the above-referenced U.S. Pat. No. 5,967,293) may be used to set the duration of motor 70 activation. Such a variable resistor may thus program the time delay provided by another circuit element such as the primary circuit chip 102. The time of the sequence may thus be proportional to the resistance presented by such a potentiometer as manually controlled by the user.

The details of a preferred electrical circuitry configuration for the present invention are shown in FIGS. 4 and 5. Though it is understood that other circuit elements and/or configurations may be used to obtain the above-described functions of the present invention, the preferred circuit details will now be set forth. These circuit diagrams generally include known circuit devices such as switches 96, 97, 98, a primary circuit chip module 102, and amplifiers 104, 105. Each of these are connected to each other in generally understood ways. Also, a standard power supply (not shown) provides power as understood through a power line 107. Note, two general versions of power supply are preferred; one which is a direct 24 volt power source and the other, a common 110 volt source. However, all of the preferred internal circuit components use 24 volts DC; so, a rectifier 106 and/or a step down transformer (not shown) may be desired/needed between the circuitry shown and an AC source and/or a 110 volt source if these other types of power supply are to be used. From this point onward in this description, it will be assumed that 24 volt DC power is supplied, at least after rectifier 106.

As shown in FIG. 5, the power connections from rectifier 106 are connected to the primary circuit chip 102 and to the on/off switch 96 (preferably a single-pole, single throw; SPST) which when properly activated (i.e., switched to close the circuit) provides power to the other circuit elements. This includes providing a hot connection to jog push-button switch 97. As described briefly above, when switch 97 is closed, this directly turns on motor 70 to ultimately turn drum 45 to move belt loop 46 in standard, continuous conveyor belt fashion. Belt motion would continue for the period of time that switch 97 is physically held closed, and/or as modified by the other circuit elements, particularly chip 102 through which jog switch 97 is connected to the motor 70. Thus, switch 97 may provide what is, in effect, a manual override/control of the other portions, e.g., the sensor portions (to be described) of the rest of the system.

One means for halting the movement of the belt 46 once it has been started by the triggering of electromagnetic wave beam (eyebeam or optical beam) between the sensors 28, 29 may be the re-completion of the wave beam between the sensors 28, 29 after the component part 50 has moved out from therebetween. The mere re-completion of this beam may, depending upon the circuitry used, be sufficient to trigger the stoppage of the motor and belt until the next component part is placed therebetween to start the cycle over again.

Alternatively, a time delay may control the stoppage of the motor 70 and belt 46. As introduced above, this is not explicitly shown here but may be activated as shown and described in U.S. Pat. No. 5,967,293.

As a further alternative (or in addition to either of the above or other stoppage alternatives), the second set of sensors 30, 31 may be used to stop belt movement. For example, if one component part placement on the belt 46 would be desired to have that component part moved through the complete length of the belt 46 to the second sensor location, then the second set of sensors would merely sense the arrival of that component at that location by the electromagnetic wave breakage, as described above. Similarly though distinctly, the second sensors 30, 31 may be used to signal when the belt 46 has become filled with parts, specifically when the parts reach the location between sensors 30, 31 and again break the electromagnetic wave beam therebetween. Thus, this alternative may be used with the other stoppage embodiments in which the belt 46 takes/receives multiple component parts thereon, stopping after opening sufficient room for the disposition of additional component parts thereon. But then, when full and a component reaches the second sensor location, this may trigger not only a belt stoppage but also an alarm sounded, for example, through a speaker element 110 (see FIGS. 4 and 5). Upon stoppage, especially in this last embodiment, an operator may be required to unload the belt 46 and thus also re-initiate the automated process of component handling; reception and transportation.

Alternatively, the sensors 30, 31 may only signal an alarm (or perhaps only a counting feature, or some similar maximum iteration function which could stop the belt after a certain number of iterations), rather than an immediate belt stoppage function. In such an alternative, a preferred additional structural element would be the inclusion of a receptacle such as the receptacle 40 shown in the embodiment of FIG. 2. Thus, the receptacle 40 would catch component parts after they would pass the sensors 30, 31.

An amplifier 105 is preferably also used with sensors 30, 31 in such a fashion as is known and as generally described for amplifier 104 above. Amplifier 105 receives an “off” signal from the sensors 30, 31 like the “on” signal that would be sent from the first set of sensors 28, 29 to amplifier 104. When amplifier 105 receives the proper signal from sensors 30, 31, then, according to its understood internal workings, amplifier 105 produces an “off” signal which it sends to the chip 102 which stops the power supplied to motor 70 (or activates the alarm 110 or activates other actions as introduced herein).

The manufacture of a conveyor belt device 20 according to the present invention follows fairly conventional techniques for machining and assembling the various parts. More specifically, almost all of the parts are preferably made from metal, such as from aluminum (6061-T6) or stainless steel (303 S.S.). These parts are cut, drilled, routed or otherwise shaped or formed according to know procedures and they may also be plated or otherwise processed after forming; including, for example, sulfiic anodizing (black) or electroless nickel plating.

The generally non-metallic, pre-manufactured parts included in the present invention comprise, for example, the circuit components and the belt. The belt may be made of any known material such as leather, fabric or rubber, or the like. A preferred belt 46 is one obtained from BELT POWER, part number U8W. The preferred electrical components include optical sensors 28, 29, 30, 31 and amplifiers 104, 105 from KEYENCE, numbers PS-52 and PS2-61, for example; and switches 96, 97, 98. Motor 70 may preferably be a PITTMAN gear motor manufactured by Pittman, Inc., Harleyville, Pa. 19438-0003.

The details of the internal structures of these components (particularly chip 102) will be known to and/or understood by those skilled in the relevant art. Thus, it will be understood how these devices, in this preferred embodiment, operate and what other structures are equivalents thereto.

Assembly of the various parts is, as shown in the drawings, performed according to known methods. Herein, various types of screws, bolts or like fasteners are used to attach many corresponding parts to one another. Means understood to be equivalent may also be used.

A brief description of one cycle of operation using generic terminology will now be presented in order to illustrate the coaction of the principal portions of this invention. First, component reject conveyor 20 is positioned in or near an electronics assembly line. Then, a rejected type or types of components are placed on the conveyor means. Then the conveyor means starts operating (belt 46 starts moving). More particularly, a pickup machinery head carrying the rejected component first comes to a position just over the receiving area and places one (or more) components between the sensors 28, 29. The control means, detecting that the pickup machine head has deposited a component (or components) and/or that it has entered the vicinity of the receiving area and initiates the forward movement of the conveyor means for an interval of time long enough to allow the next component to be deposited therebehind, or until it arrives at the second set of sensors 30, 31 as described above.

As mentioned, the conveyor means does not preferably operate continuously throughout a cycle, rather, the conveyor means starts and stops as controlled by the action of the pick and place machine depositing newly rejected parts thereon. This helps to avoid the abrasive wear on components which appears to be prevalent in the component reject conveyor art. As this process or cycle continues, the number of components on the conveyor is increased, however, the conveyor can be unloaded as the need arises without significantly interrupting or interfering with the overall operation between of component reject conveyor and the pick-and-place machinery.

The detailed operation of component reject conveyor 20 will now be presented. Component reject conveyor 20 is designed to be used with an electronics assembly system. Bolts, for example, or a quad latch mechanism familiar in the robotic and/or automated pick-and-place machinery field, may be used to secure housing 22 to the mounting surface. Component reject conveyor 20 can be configured to operate on a power level of 120VAC, 24VAC or 24VDC.

To make component reject conveyor 20 ready for operation, surface mounted electronic components are fed to the assembly pick and place or robotic machinery as is known in the art. The automated machinery then determines the suitability of the component or components, and if/when it determines certain parts should be rejected, it then moves this/these component part(s) to the component reject conveyor 20. The component(s) may then be set down on the conveyor belt 46. The power system would first have been activated (turned “on”) by switching the on/of switch 96. Then, the jog push-button switch 97 may be depressed to activate conveyor belt 46 to then advance the components in their respective conveyor guide lanes 42 or more preferably, the sensors 28, 29 are triggered to move the belt 46 until the first component moves the appropriate, pre-programmed distance (or time) or it arrives at the second set of sensors 30, 31. The jog switch 97, if used in this process, may then be released, or the sensors 30, 31 could trigger a belt stoppage. A component may then be removed from the belt by an operator to check its potential insufficiency. Further components will also be placed on the belt 46 between sensors 28, 29 and these will detect their presence (by the breaking of the beam circuit) and thus automatically restart belt movement to open the receiving area for future reception of new rejected component(s). Sensors 28, 29 and 30, 31 may need to be physically adjusted because they should be located in the position closest to matching the common component centerline. Component reject conveyor 20 is then ready for further automatic operation.

As it will be preprogrammed (in known fashion) to do, the pick and place or robotic machine head (hereafter “pick/place head”) (not shown) will repetitively arrive at a location immediately above the reject receiving area which receives the component or components which were “rejected”. The pick/place head (or the component itself) then breaks the optical sensor beam and deposits up one or more components in proper placement on the conveyor belt 46. When the pick/place head has completed its “placement”, it leaves the vicinity of the receiving location. The belt moves forward until the optical sensor beam is then recompleted between sensor 28, 29, i.e., is re-unobstructed which in the preferred embodiment, thereby triggers the conveyor belt to stop the advance of the belt, and then await the next component to be deposited there. The pick/place head may then return and repeat the cycle anew.

The system as described above, is implemented in an electromechanical circuit. However, the circuitry can also be implemented using digital controls. This increases the flexibility and timing of the system, while maintaining all of the same mechanical components, motor 70, for example. Such a system may then be sequenced and timed using software (or firmware, etc.) located within the digital controls. This allows changes to the timing of the dwell, motor, brake, power-on, jog, speed and timing without any hardware changes to the system.

Please note also, that regardless whether the preferred circuitry, described here, or digital controls are used in conveyor 20, the details of the logic structures (firmware, software, microprocessors or otherwise) are known or will be readily understood by those skilled in the art. Thus, even if the separate timing, delay or other related means for controlling the motor(s) are incorporated in one or more structures expressly disclosed here, those skilled in the art will know how to replicate this invention using the disclosed structures or their equivalents (firmware, software, microprocessors or the like).

In use, the device 20 embodying the present invention is mounted upon, and interactively coacts with a host pick and place machine, and is locked into place to assure proper alignment. When the device is put in use, several modes of operation may be selected by the operator by the combined selection of several options.

The first mode controlling option is whether the conveyor is placed in Reject or Supply mode. This mode in the bi-directional embodiment of the present invention, controls the direction of travel of the conveyor belt. This done through a simple switch. This overriding mode then allows for the utilization of several hierarchical operator options, as is described more fully below. The unidirectional and bi-directional embodiments of the present invention as configured for a particular host, operate in a substantially identical manner, when they are operated in Reject mode, only the bi-directional embodiment can be operated in Supply mode.

Within the Reject mode, the operator, or host machine, controllable options involve the Advance mode, the Stop mode, and the availability, to the operator, to use the jog over ride control. The jog control, allows the belt to be advanced a selectable preset amount, when operator activated, regardless, of the automatic control inputs received by the device, if the jog control is enabled.

In a hierarchical sense, if Reject mode has been selected, the presence of the scrap bin is equal to the power switch of the invention. Device 20, since placing either switch in the “off” position will deactivate the entire device. At the next level, the selection of the stop mode takes priority. Two stop modes exist, Full Stop and Regular Stop.

If the Full Stop mode is selected, no component will advance past the stop sensor at the delivery end of the belt. A part activating the stop sensor causes two events to take place. First, the activation of the stop sensor causes the belt to stop. Second, the activation of the stop sensor initiates the stop sensor alarm means which can be audible, visible or both as desired. If Full Stop mode is selected, and the stop sensor is activated, the jog control is disenabled for the duration of the stop sensor output.

The alarm indicates that a part needs to be hand-picked, and may also indicate that no further additional rejected parts can be accepted from the host machine. As desired by the operator, different alarm signals may be generated depending upon the selected mode of operation. The alarm is only deactivated when the part activating the stop sensor is moved from the operating range of the stop sensor.

While the Full Stop mode takes precedence over all other operational choices, Regular Stop mode does not. Regular Stop mode allows the operator full freedom to select and implement the operating mode desired. The next choice for the operator is whether to select Step Advance or Full Advance mode, subject to the limitations imposed by the possible selection of Stop mode. In Full Advance mode, once a component is deposited upon the conveyor, the part is transported until the stop sensor is activated. The belt also continues in operation until the stop sensor is activated. If the part being transported on the belt is removed from the belt without the stop sensor being activated, the belt will continue to run until the time allowed for the overall dwell potentiometer is reached, at which time the belt will cease operating.

As described above, once the stop sensor is activated, the belt and the part thereupon stop. However, when a new part is placed on the belt by the host, the belt is again activated and the new part is transported until it activates the stop sensor. during this process, the belt transports the old part, if it has not been removed from the belt, into the scrap bin at the delivery end of the belt.

If Full Advance mode is selected in conjunction with Stop mode, the maximum number of rejected parts that can be on the belt at any given time is small. In fact, if Full Advance mode is selected, and the operator has the option of activating the Joy Button, each part may be the only part on the belt at any given time.

If Step Advance mode is selected, the invention operates in a somewhat different manner. Placing a part on the belt, causes the belt to advance only a relatively small preset distance, sufficient to clear the deposit site. In this mode, many parts may be on the belt at once. Step Advance mode is compatible with both Regular and Full Stop mode, and, depending upon the stop mode selected, may also enable the Jog button. Regardless of the operating mode combination selected, the speed of the belt is selectable and adjustable by the device operator.

From the foregoing, it is readily apparent that a useful embodiment of the present invention has been herein described and illustrated which fulfills all of the aforestated objectives in a remarkably unexpected fashion. It is of course understood that such modifications, alterations and adaptations as may readily occur to the artisan confronted with this disclosure are intended within the spirit of this disclosure which is limited only by the scope of the claims appended hereto.

Accordingly, what is claimed is:

1. A device for receiving an electronic component from a host comprising intermittently operable conveyor belt means, belt drive means, control means, alarm means and receptacle means.

2. A device according to claim 1, wherein said control means comprise selectively programmable means.

3. A system device to claim 2, wherein said selectively programmable control means interact in a predetermined hierarchical manner.

4. A device according to claim 3, wherein said belt means is bi-directional.

5. A device according to claim 3, wherein said control means comprise a stop sensor, a start sensor, power switches and hierarchical programmable logic means.

6. A device according to claim 5, wherein said programmable logic means and said stop means may coact so as to prevent said component from passing through the domain of said stop sensor.

7. A device according to claim 6, wherein said receptacle means operatively interact with said power switch.

8. A device according to claim 4, wherein said control means comprise a stop sensor, a start sensor, power switches and hierarchical programmable logic means.

9. A device according to claim 8, wherein said programmable logic means and said stop means may coact so as to prevent said component from passing through the domain of said stop sensor.

10. A device according to claim 7, wherein said programmable logic means and said stop means may coact so as to prevent said component from passing through the domain of said stop sensor.

11. A device according to claim 10, wherein reversing the direction of travel of said belt reverses the functions of said stop sensor and said start sensor without otherwise affecting the settings of said logic means.

12. A device for safely accepting and transporting surface mount electronic components comprising an antistatic conveyor belt, belt drive means, a first power switch means, a second power switch means operatively connected to a scrap receptacle, a start sensor, a stop sensor, control means and programmable logic means.

13. A device according to claim 12 having a plurality of advance modes.

14. A device according to claim 13 having a plurality of stop modes.

15. A device according to claim 14, also having a manual advance switch that is subservient to said logic means.

16. A device according to claim 15, where the direction of travel of said belt is selectable.

17. A device according to claim 16, wherein activating said stop sensor enables an alarm means, subject to the programming of said logic means.

18. A method of accepting rejected surface mount electronic parts for later inspection comprising attaching a controllable, programmable, intermittently operable conveyor belt to a host, wherein said host selects a part, inspects said part, compares said part with a pre-established standard, and deposits said parts which fail said comparison upon said conveyor belt.

19. A system for storing rejected surface electronic parts pending subsequent inspection comprising an anti-static controllable, programmable, intermittently operable conveyor belt operably connected to a host pick and place machine having a designated deposit point, a selectively actuable manual override, an actuation sensor, host controllable cycle and an alarm means.
